(19) United States
(12) Patent Application Publication
(10) Pub. No.: US 2001/0032909 A1
(43) Pub. Date: Oct. 25, 2001

(54) Universal exhaust system for motorcycles

(75) Inventor: Terry L. Goettle, Olmsted Township, OH (US)

Correspondence Address: Jay F. Moldovanyi, 1100 Superior Ave., 7th Floor, Cleveland, OH, 44114, US

(73) Assignee: Supertrapp Industries

(21) Appl. No.: 09/774,128

(22) Filed: Jan. 30, 2001

Related U.S. Application Data
(60) Provisional application No. 60/181,135, filed on Feb. 8, 2000.

(51) Int. Cl. F16L 3/00; B62M 7/00

(52) U.S. Cl. 248/58; 180/228; 248/567; 248/74.3; 180/309

(57) ABSTRACT

A universal mounting assembly for mounting exhaust pipe components to several different types of motor vehicles includes a bracket body having a mounting portion, an intermediate portion, and a support portion. The mounting portion has a first aperture and a second aperture spaced from the first aperture. The support portion includes a planar member, a first aperture located in the planar member, and a second aperture located in the planar member with the second aperture being spaced from the first aperture. First and second fasteners extend through the first and second apertures of the mounting portion for securing the mounting portion to a structural portion of an associated vehicle. The mounting portion is located in a first plane with the support portion being located in a second plane spaced from the first plane. The first and second planes are approximately aligned with the second plane being oriented at, at most, an acute angle in relation to the first plane.

### BACKGROUND OF THE INVENTION

This application bases its priority on Provisional Application Ser. No. 60/181,135 dated Feb. 8, 2000.

The present invention relates to exhaust systems and means for securing tubular exhaust elements to a support surface. More particularly, this invention relates to a universal exhaust system for motorcycles.

Brackets for securing exhaust system components to a vehicle frame or body are commonly known. The exhaust pipe and tailpipe sections of modern vehicles are of intricate shape due to the requirement that they fit in spaces which are available after the design of the vehicle, such as a motorcycle, has been completed. Consequently, in the past, it has been necessary for each model of motorcycle to use a variety of clamp structures or to weld the brackets to the tailpipe or exhaust pipe thereby increasing the cost of the pipe and making the pipe more difficult to handle and put in place.

Another disadvantage of known exhaust system mounting brackets, especially as used on motorcycles, is that the brackets commonly mount the tailpipe or muffler to the frame of the vehicle. Therefore, for each change in the vehicle's frame, the bracket would need to be redesigned. In other words, every time a motorcycle manufacturer made changes in the design of a frame, the exhaust manufacturer would need to redesign its mounting brackets to accommodate these changes.

A further disadvantage of conventional motorcycle exhaust system mounting brackets is that the head pipes to which the mufflers or tailpipes are connected are subjected to flexing and potential cracking because the head pipes are secured to the engine whereas the mufflers or tailpipes are secured to the frame. As the engine moves in relation to the frame, stress is exerted on the head pipes since the mufflers and tailpipes are bolted to the frame.

It has therefore been considered desirable to develop a new and improved universal exhaust system for motorcycles which overcomes the foregoing difficulties and others while providing better and more advantageous overall results.

### BRIEF SUMMARY OF THE INVENTION

In accordance with one aspect of the present invention, a mounting bracket assembly is provided for exhaust pipe components of a motor vehicle.

More particularly, in accordance with this aspect of the invention, the exhaust assembly comprises a bracket body comprising a mounting portion and a support portion. The mounting portion comprises a first mounting flange and a second mounting flange spaced from the first mounting flange, wherein the first and second mounting flanges are located in a first plane. The support portion comprises a planar member which is located in a second plane spaced from the first plane. The first and second planes are approximately aligned with the second plane being oriented at, at most, an acute angle in relation to the first plane.

In accordance with another aspect of the present invention, a mounting bracket assembly is provided for exhaust pipe components of a motor vehicle.

More particularly, in accordance with this aspect of the invention, the mounting bracket assembly comprises a bracket body having a mounting portion, an intermediate portion, and a support portion. The mounting portion comprises a first aperture and a second aperture spaced from the first aperture, wherein the mounting portion is located in a first plane. The support portion comprises a planar member, a first aperture located in the planar member and a second aperture located in the planar member, with the second aperture being spaced from the first aperture. The support portion is located in a second plane spaced from the first plane. The first and second planes are approximately aligned.

In accordance with still another aspect of the present invention, a universal mounting bracket assembly is provided for mounting exhaust pipe components to several different types of motor vehicles.

More particularly, in accordance with this aspect of the present invention, the mounting bracket assembly comprises a bracket body comprising a mounting portion, an intermediate portion, and a support portion. The mounting portion comprises a first aperture and a second aperture spaced from the first aperture. The support portion comprises a planar member, a first aperture located in the planar member and a second aperture located in the planar member, with the second aperture being spaced from the first aperture. First and second fasteners extend through the first and second apertures of the mounting portion for securing the mounting portion to a structural portion of an associated vehicle. The mounting portion is located in a first plane with the support portion being located in a second plane spaced from the first plane. The first and second planes are approximately aligned with the second plane being oriented at, at most, an acute angle in relation to the first plane.

One aspect of the present invention is the provision of a new and improved universal exhaust system for vehicles, such as motorcycles.

Another aspect of the present invention is the provision of an exhaust system which will fit a wide variety of motorcycles such as various models of Harley Davidson motorcycles and similar heavy motorcycles for a number of model years. These can include various models of American Ironhorse, American Quantum, Boar, Big Dog, California Customs, California Motorcycle Co., Desperado, Indian, Lifestyle, Panzer, Pure Steel, Surgical Steeds, Titan, Ultra Cycle, and Wild West motorcycles.

Still another aspect of the present invention is the provision of an exhaust system which fits a wide variety of applications thereby minimizing the exhaust system types which a distributor needs to stock to accommodate a variety of motorcycles.

Yet another aspect of the present invention is the provision of an exhaust system which is usable for a wide range of motorcycle types thus allowing customers to more readily obtain the desired exhaust system at a reasonable cost and in a timely manner.

A further aspect of the present invention is the provision of an exhaust system bracket which mounts to a transmission case of a motorcycle and therefore “floats” with the engine. This helps to eliminate any flexing and fatigue cracking of the head pipe of the motorcycle.

A still further aspect of the present invention is the provision of an exhaust system bracket which can be used to mount mufflers and tailpipes to a variety of models of motorcycles of various manufacturers and thus can be fairly termed a “universal” bracket.

### DESCRIPTION OF THE DRAWINGS

The invention may take physical form in certain parts and arrangements of parts, several embodiments of which will be described in detail in this specification and illustrated in the accompanying drawings which form a part hereof and wherein:

FIG. 1 is an exploded perspective view of a known motorcycle muffler mounting bracket;

FIG. 2 is an exploded perspective view of another known motorcycle muffler mounting bracket;

FIG. 3 is an exploded perspective view of a universal muffler mounting bracket for motorcycles according to a first preferred embodiment of the present invention;

FIG. 4 is a front elevational view of the mounting bracket of FIG. 3;

FIG. 5 is a side elevational view of the mounting bracket of FIG. 3;

FIG. 6 is a cross-sectional view of the mounting bracket of FIG. 5 along line 6-6;

FIG. 7 is an exploded perspective view of a known tailpipe mounting bracket for motorcycles;

FIG. 8 is an exploded perspective view of a universal tailpipe mounting bracket for motorcycles according to a second preferred embodiment of the present invention;

FIG. 9 is a top plan view of the mounting bracket of FIG. 8;

FIG. 10 is a side elevational view of the mounting bracket of FIG. 8; and,

FIG. 11 is a side elevational view of a universal tailpipe mounting bracket for motorcycles according to a third preferred embodiment of the present invention.

### DETAILED DESCRIPTION OF THE PREFERRED EMBODIMENTS

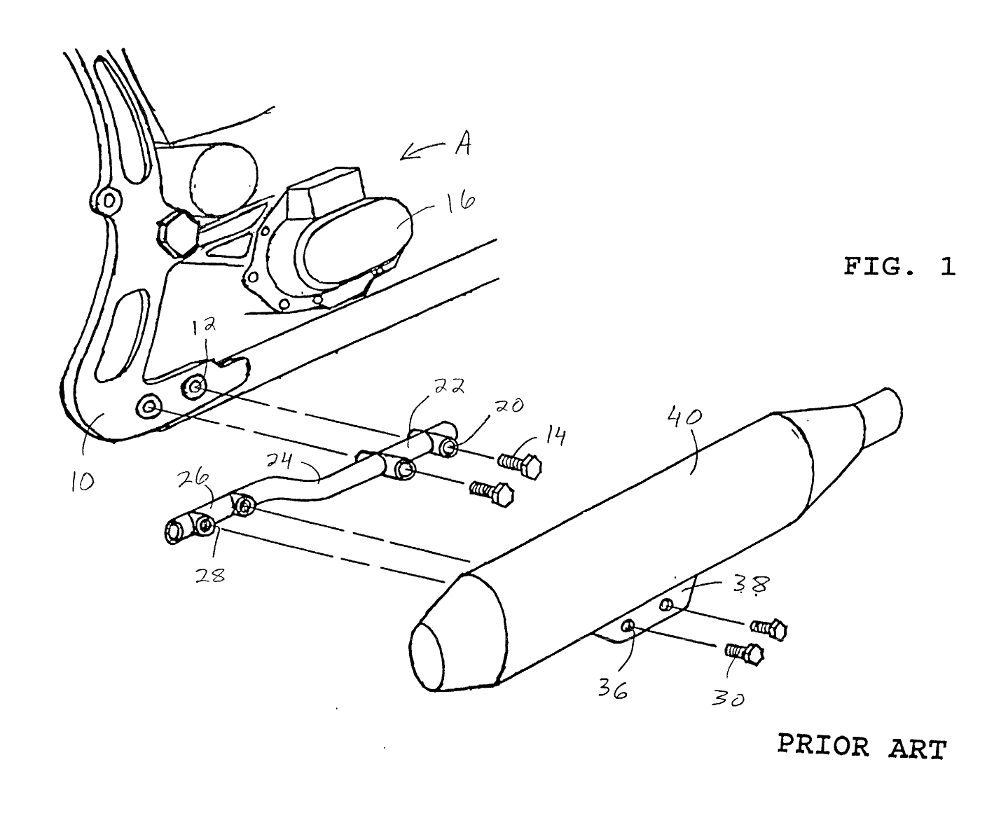

Referring now to the drawings, wherein the showings are for purposes of illustrating preferred embodiments of the invention only and not for purposes of limiting same, FIG. 1 illustrates a known mounting bracket for the muffler of a known motorcycle A, which can be a Harley Davidson cycle. The motorcycle includes a frame 10 having a plurality of apertures 12 which accommodate fasteners 14. The motorcycle also includes a transmission 16 located adjacent an engine (not illustrated). Suitable apertures 20 are located on a mounting portion 22 of a known muffler mounting bracket 24. The bracket 24 also includes a support portion 26 having apertures 28 for accommodating fasteners 30. The fasteners 30 extend through apertures 36 in a mounting flange 38 of a muffler 40. As may be appreciated, the muffler 40 is thus secured via the bracket 24 to the frame 10 of the motorcycle A. This known mounting arrangement is disadvantageous because it requires the redesign of the mounting bracket for each change in the frame of the motorcycle. It is also disadvantageous because the head pipe assembly (not illustrated) of the motorcycle is subjected to flexing and potential cracking since the muffler is mounted rigidly to the frame while the head pipe assembly is mounted in a “floating” manner to the engine.

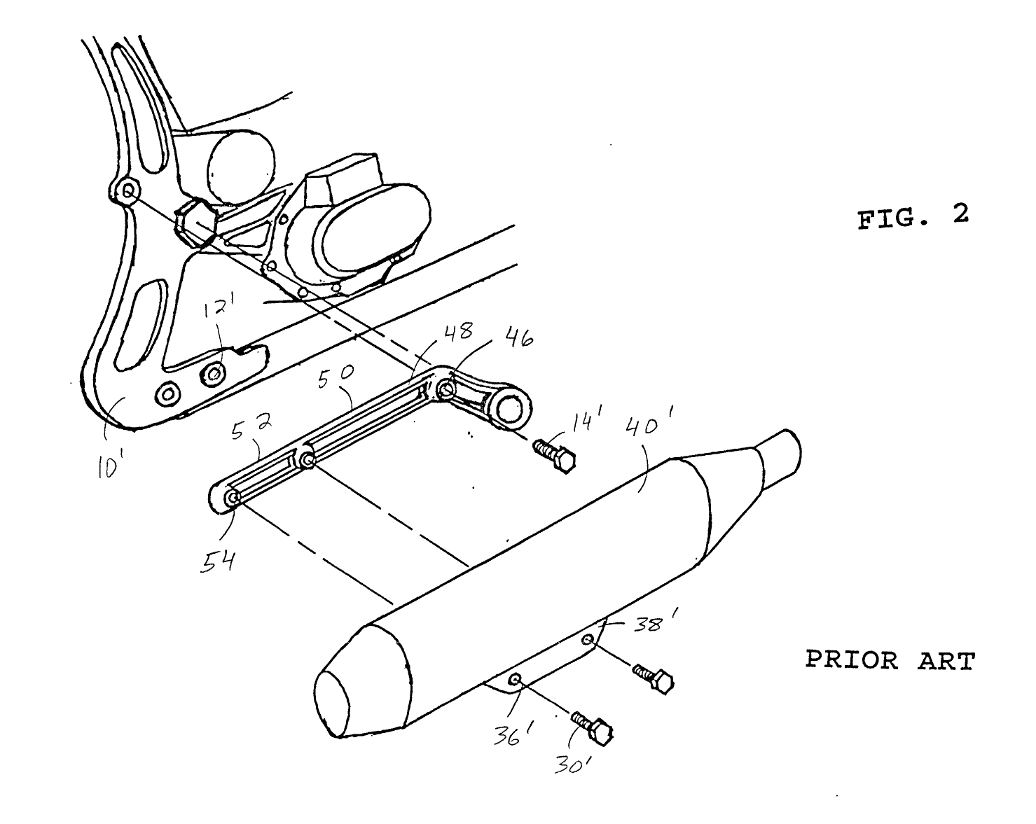

With reference now to FIG. 2, another known type of tailpipe bracket is there illustrated. For ease of illustration and appreciation of this bracket, like components are identified by like numerals with a primed (′) suffix and new components are identified by new numerals. In this known assembly, a motorcycle frame 10′ is provided with apertures 12′, for accommodating fasteners 14′. Each fastener 14′ extends through a respective aperture 46 in a mounting portion 48 of a known bracket 50. The bracket also includes a support portion 52 having spaced apertures 54 for accommodating fasteners 30′ which extend through respective apertures 36′ in a mounting flange 38′ of a muffler 40′. This mounting arrangement has the same disadvantages as the previous one mentioned above.

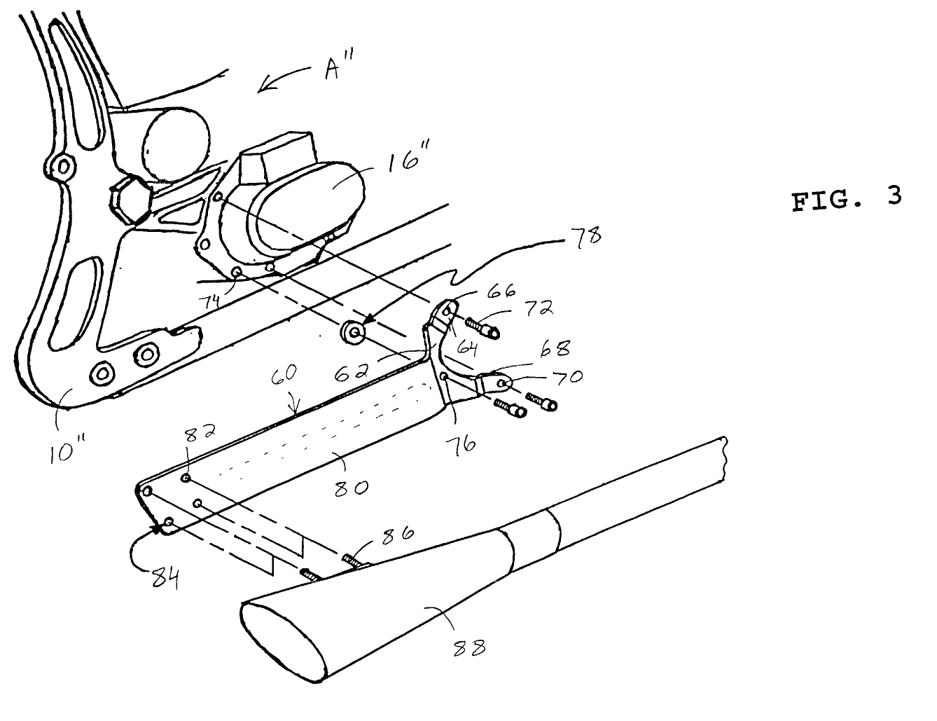

With reference now to FIG. 3, a universal muffler bracket according to the present invention is there illustrated. For ease of understanding and appreciation of this embodiment, like components are identified by like numerals with a double primed (″) suffix and new components are identified by new numerals. The universal muffler bracket comprises a bracket body 60 including a mounting portion 62 having a first mounting flange 64 that has an aperture 66 extending therethrough and a second mounting flange 68 which also has an aperture 70 extending therethrough. Suitable fasteners 72 extend through the apertures 66 and 70 and into respective aligned apertures 74 in a case of a transmission 16″ of a motorcycle A″.

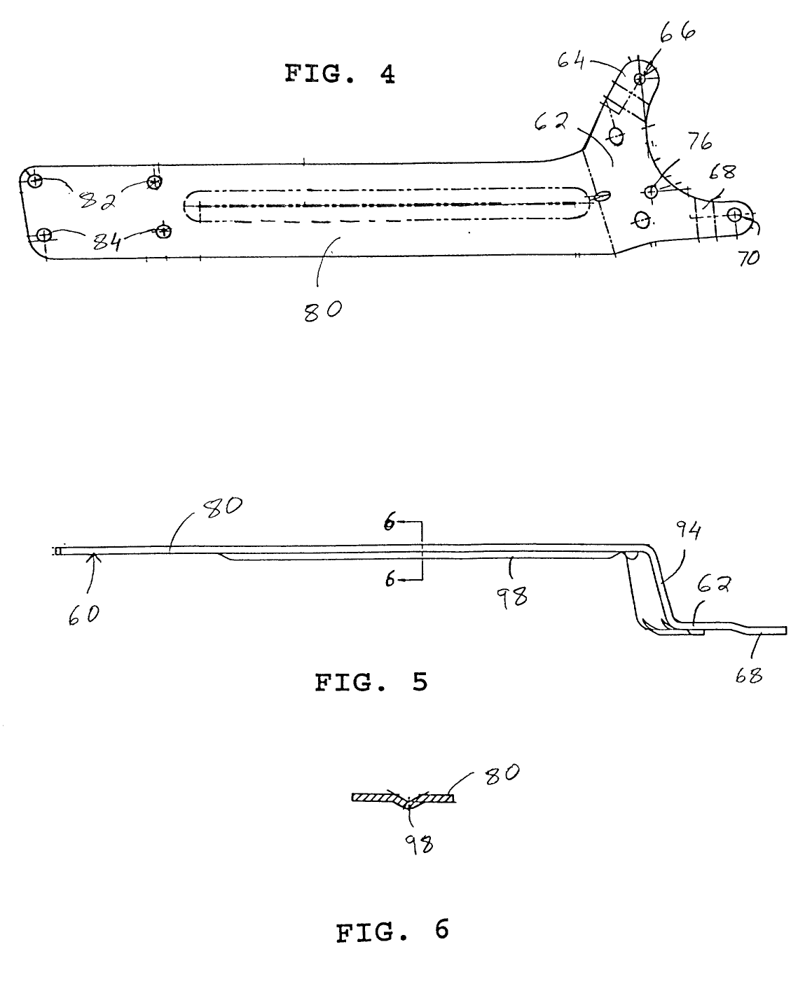

With reference now also to FIG. 4, the mounting portion 62 also includes a third aperture 76 which is aligned with another aperture 74 in the case of the transmission 16″. If necessary, a spacer 78 (FIG. 3), can be employed with the third aperture 76. The spacer would be omitted if a brake light sender (not illustrated) is mounted in this aperture in the transmission case. The bracket 60 also includes a support portion 80 having a first or upper pair of apertures 82 and a second or lower pair of apertures 84. Each of these pairs of apertures can accommodate a pair of spaced fasteners 86 secured on a muffler 88 of the motorcycle. The upper set of apertures 82 is normally used except when the engine is rubber mounted. In that case, the lower set of apertures 84 is employed. Since two sets of apertures are provided, the bracket can accommodate different types of motorcycles. Also, because the bracket is mounted to the transmission case of the motorcycle, frame changes do not affect its useability. It should be noted that the transmission case of a motorcycle is not redesigned nearly as often as is the frame of the motorcycle. Also, by mounting the bracket to the transmission case, the exhaust system “floats” with the engine. This mounting arrangement reduces the potential for flexing and cracking of the head pipes of the motorcycle.

With reference now to FIG. 5, it is evident that the bracket mounting portion 62 is offset from the support portion 80 and is connected thereto by an intermediate portion 94. It should also be appreciated that the first and second mounting flanges 64 and 68 (FIG. 4), are slightly offset from the plane of the remaining section of the mounting portion 62. With reference now to FIG. 6, it can be seen that a reinforcing rib 98 extends along a longitudinal axis of the support portion 80. The rib protrudes from a lower surface of the support portion.

The invention disclosed in FIGS. 3-6 is useful for a 2:1 system in which two pipes converge into a collector and the collector, in turn, routes the exhaust through one muffler 88. The bracket of the present invention is mounted to the transmission case for both a solid mount and a rubber mount type engine for motorcycles. The universal bracket of the present invention accommodates a large variety of motorcycle types as listed above. It also accommodates a variety of engine types namely big twin cylinder engines manufactured by Harley Davidson, S and S, Total Performance, Merch Engineering, Keck and STD. With the present invention, a universal exhaust system, including a common two-to-one set of pipes and a common exhaust bracket can be mounted to a large variety of motorcycles and engine types, as mentioned previously.

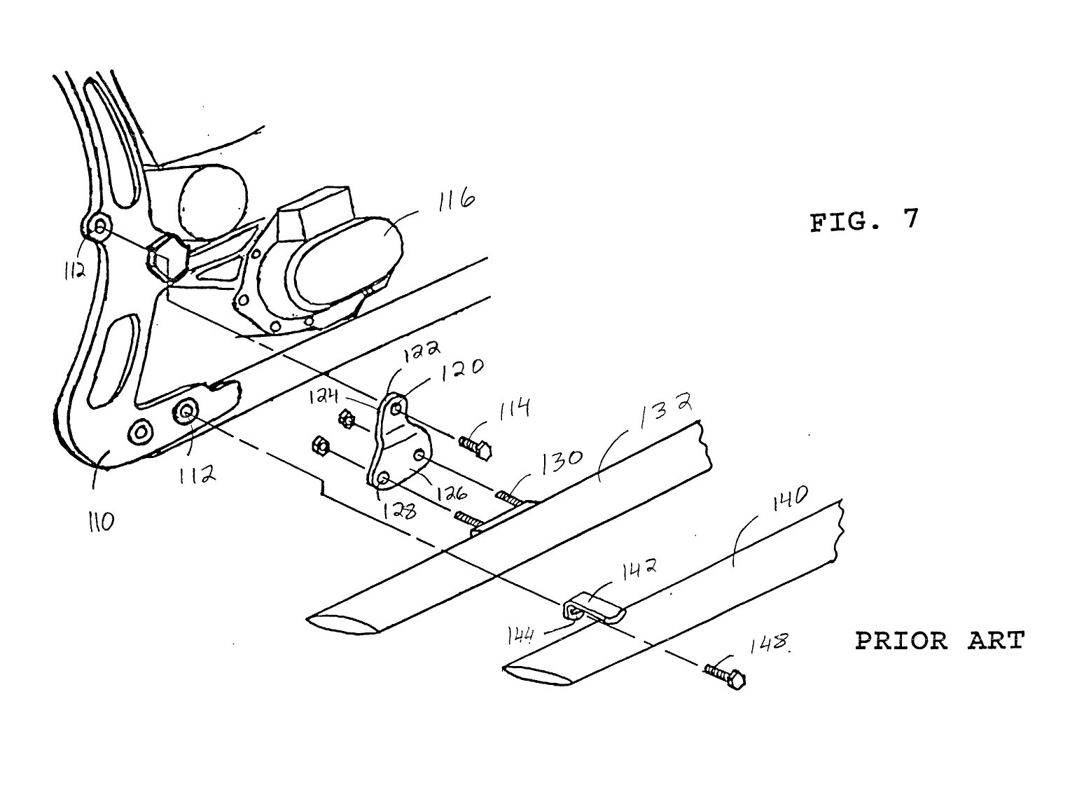

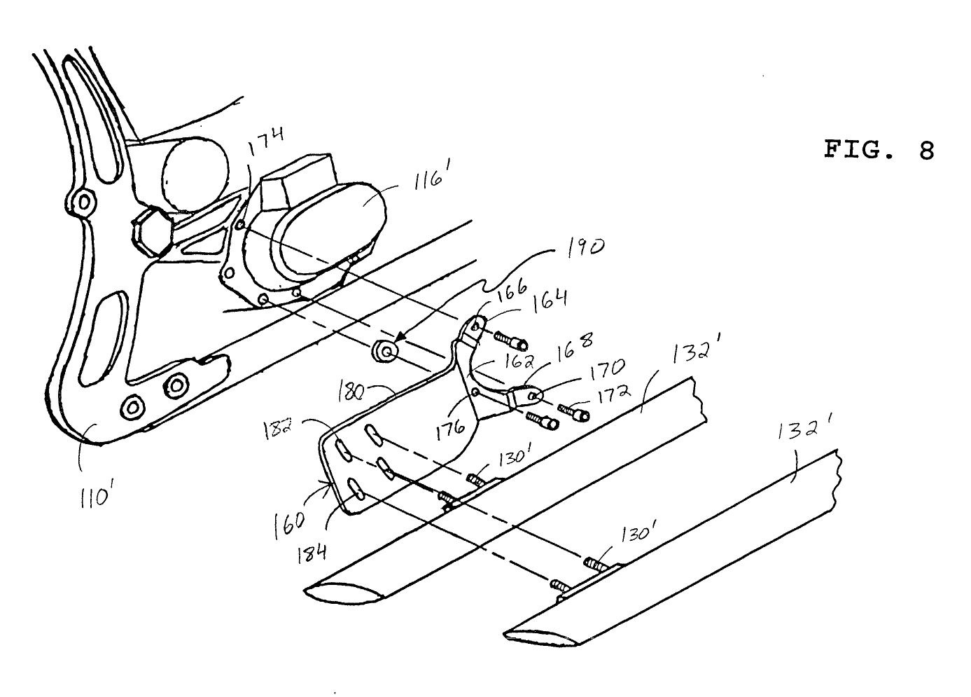

With reference now to FIG. 7, a known mounting bracket dedicated to drag pipe applications is there illustrated. Into this environment, two pipes which exit one on top of the other alongside of the motorcycle need to be supported on the motorcycle. A known motorcycle includes a frame 110 having a plurality of apertures 112 which accommodate fasteners 114. The motorcycle also includes a transmission 116 located adjacent an engine (not illustrated). Suitable apertures 120 are located on a mounting portion 122 of a known tailpipe mounting bracket 124. The bracket 124 also includes a support portion 126 having a pair of spaced apertures 128 for accommodating fasteners 130. Fasteners 130 are secured to a first tailpipe 132. A second tailpipe 140 has secured thereto a second bracket 142. The second bracket has an aperture 144 extending therethrough. The aperture 144 is aligned with one of the apertures 112 in the frame 110 of the motorcycle. A suitable fastener 148 extends through the aligned apertures 144 and 112 to secure the second tailpipe 140 to the frame 110. In this arrangement, the mounting bracket 124 secures the first tailpipe 132 to the frame at an upper aperture 112 whereas the second bracket 142 secures the second tailpipe 140 to the frame via another aperture 112 vertically spaced from the first aperture. This tailpipe mounting arrangement is disadvantageous for the same reasons as outlined previously.

With reference now to FIG. 8, a second preferred embodiment of the present invention relates to a mounting bracket which is capable of accommodating such drag pipes. For ease of understanding and appreciation of this embodiment, like components are identified by like numerals with a primed (′) suffix and new components are identified by new numerals.

In this embodiment, a universal tailpipe bracket 160 is employed to secure a pair of spaced aligned exhaust pipes 132′ to a motorcycle. The bracket 160 includes a mounting portion 162 having a first mounting flange 164 through which extends a first aperture 166. A second mounting flange 168 is spaced from the first mounting flange. A second aperture 170 extends through the second mounting flange. Suitable fasteners 172 are employed to secure the mounting portion 162 of the bracket 160 in aligned apertures 174 in a case of a transmission 116′ of the motorcycle. Also provided on the mounting portion is a third aperture 176, which is aligned with another transmission case aperture 174.

The bracket 160 also includes a support portion 180. Located in the support portion are a pair of first, upper apertures 182 and a pair of second, lower apertures 184. Each of these pairs of apertures are meant to accommodate suitable fasteners 130′ extending from each of the two tailpipes 132′.

If necessary, a spacer 190 can be employed. This spacer would be omitted in applications where a brake light sender (not illustrated) is mounted in this aperture in the transmission case.

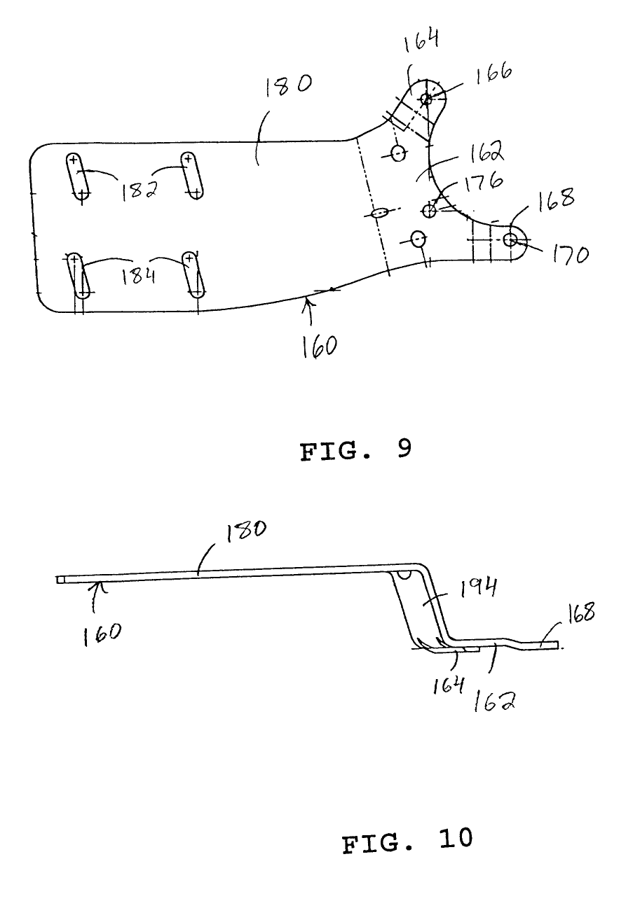

With reference now to FIG. 9, it is apparent that the support portion 180 is located in a different plane than is the mounting portion 162 of the bracket 160. An intermediate portion 194 of the bracket 160 connects the mounting portion to the support portion of the bracket. It is also apparent that the first and second mounting flanges are somewhat displaced from the plane of the remainder of the mounting portion.

The universal mounting bracket 160 is advantageous from the standpoint that it can accommodate a pair of spaced exhaust pipes on a single bracket. This in contrast with the necessity to use two brackets as known in the prior art. Moreover, due to the use of elongated slots 182 and 184 in the support portion 180 of the bracket 160, tailpipes having fasteners located at a variety of positions can be supported by the bracket. In addition, because the mounting portion 162 of the bracket is secured to the transmission case of the motorcycle, the instant mounting bracket reduces the potential for flexing and cracking of the head pipes of the motorcycle.

With reference now to FIG. 11, a third preferred embodiment of the present invention is there illustrated. In this embodiment, a universal tailpipe bracket 200 is employed to secure exhaust pipes to a motorcycle or other motor vehicle. The bracket 200 includes a mounting portion 202 and a support portion 210. In this embodiment, the mounting portion is aligned with a plane 212, whereas the support portion is aligned with a plane 214.

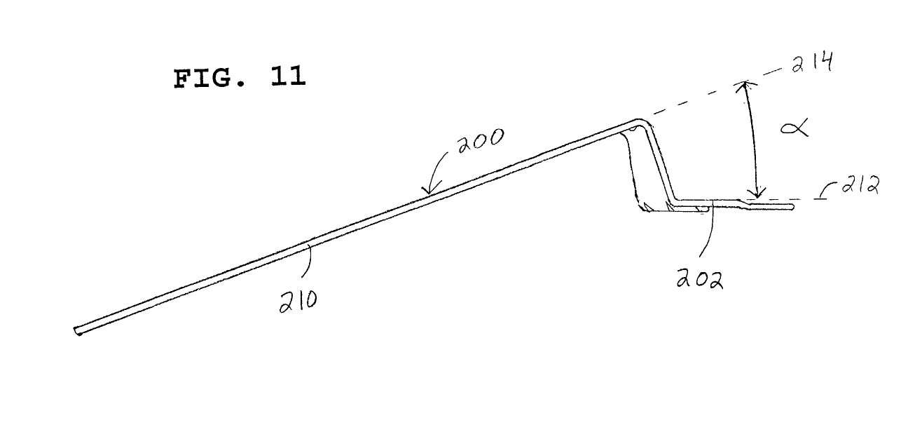

An angle α is created between the two planes. The angle α can be on the order of, e.g., 20°. Under all circumstances the angle α will be less than 90°. Preferably, the angle will be less than 45°. In contrast to the embodiment illustrated, e.g., in FIG. 10, where the planes of the mounting portion 162 and support portion 180 are approximately aligned with each other, it is possible to provide an acute angle between the two planes as illustrated in FIG. 11. A bracket construction in which the planes of the mounting portion and support portion are offset at an acute angle in relation to each other may be desirable in certain exhaust mounting environments for certain types of vehicles.

The invention has been described with reference to the preferred embodiments. Obviously, modifications and alterations will occur to others upon the reading and understanding this specification. It is intended to include all such modifications and alterations insofar as they come within the scope of the appended claims or the equivalents thereof.

I claim:

1. A mounting bracket assembly for exhaust pipe components of a motor vehicle, comprising:
a bracket body comprising a mounting portion and a support portion, said mounting portion comprising:
a first mounting flange,
a second mounting flange spaced from said first mounting flange, wherein said first and second mounting flanges are located in a first plane;
said support portion comprising a planar member which is located in a second plane spaced from said first plane, wherein said first and second planes are approximately aligned with said second plane being oriented at, at most, an acute angle in relation to said first plane.

2. The assembly of claim 1 wherein said first mounting flange comprises a first aperture extending therethrough and said second mounting flange comprises a second aperture extending therethrough.

3. The assembly of claim 2 further comprising first and second fasteners extending through said first and second apertures for securing said mounting portion to a structural portion of an associated vehicle.

4. The assembly of claim 1 wherein said support portion comprises:
a first aperture extending therethrough; and,
a second aperture extending therethrough, said second aperture being spaced from said first aperture.

5. The assembly of claim 4 further comprising first and second fasteners extending through said first and second apertures for securing to said support portion a structural portion of an associated exhaust system component.

6. The assembly of claim 4 wherein said first and second apertures are elongated to allow said first and second fasteners to be mounted along a length of each of said apertures to fit said bracket to a particular associated exhaust system component.

7. The assembly of claim 4 further comprising:
a third aperture extending therethrough, said third aperture being spaced from said first and second apertures; and,
a fourth aperture extending therethrough, said fourth aperture being spaced from said first, second and third apertures.

8. The assembly of claim 1 wherein said bracket further comprises an intermediate portion for connecting said mounting portion to said support portion , said intermediate portion being located in a plane which is oriented at approximately a right angle in relation to said planes of said mounting portion and said support portion.

9. The assembly of claim 1 wherein said mounting portion further comprises a bridge for connecting said first and second mounting flanges to said intermediate portion.

10. A mounting bracket assembly for exhaust pipe components of a motor vehicle, comprising:
a bracket body comprising a mounting portion, an intermediate portion and a support portion, said mounting portion comprising:
a first aperture, and
a second aperture spaced from said first aperture, wherein said mounting portion is located in a first plane; and,
said support portion comprising:
a planar member,
a first aperture located in said planar member, and
a second aperture located in said planar member, said second aperture being spaced from said first aperture, wherein said support portion is located in a second plane spaced from said first plane, wherein said first and second planes are approximately aligned.

11. The assembly of claim 10 further comprising first and second fasteners extending through said first and second apertures of said mounting portion for securing said mounting portion to a structural portion of an associated vehicle.

12. The assembly of claim 10 further comprising first and second fasteners extending through said first and second apertures of said support portion for securing to said support portion a structural portion of an associated exhaust system component.

13. The assembly of claim 12 wherein said first and second apertures of said support portion are elongated to allow said first and second fasteners to be mounted along a length of each of said apertures to fit said bracket to a particular associated exhaust system component.

14. The assembly of claim 10 further comprising:
a third aperture extending through said support portion, said third aperture being spaced from said first and second apertures; and,
a fourth aperture extending through said support portion, said second aperture being spaced from said first, second and third apertures.

15. The assembly of claim 10 wherein said bracket intermediate portion connects said mounting portion to said support portion, said intermediate portion being located in a plane which is oriented approximately transverse to said planes of said mounting portion and said support portion.

16. A universal mounting bracket assembly for mounting exhaust pipe components to several different types of motor vehicles, comprising:
a bracket body comprising a mounting portion, an intermediate portion and a support portion, said mounting portion comprising:
a first aperture, and
a second aperture spaced from said first aperture;
said support portion comprising:
a planar member,
a first aperture located in said planar member, and
a second aperture located in said planar member, said second aperture being spaced from said first aperture and,
first and second fasteners extending through said first and second apertures of said mounting portion for securing said mounting portion to a structural portion of an associated vehicle; and,
wherein said mounting portion is located in a first plane, said support portion is located in a second plane spaced from said first plane and wherein said first and second planes are approximately aligned with said second plane being oriented at, at most, an acute angle in relation to said first plane.

17. The assembly of claim 16 further comprising first and second fasteners extending through said first and second apertures of said support portion for securing to said support portion a structural portion of an associated exhaust system component.

18. The assembly of claim 17 wherein said first and second apertures of said support portion are elongated to allow said first and second fasteners to be mounted along a length of each of said apertures to fit said bracket to a particular associated exhaust system component.

19. The assembly of claim 16 further comprising:
a third aperture extending through said support portion, said third aperture being spaced from said first and second apertures; and,
a fourth aperture extending through said support portion, said second aperture being spaced from said first, second and third apertures.

20. The assembly of claim 16 wherein said bracket intermediate portion connects said mounting portion to said support portion, said intermediate portion being located in a plane which is oriented at approximately a right angle in relation to said planes of said mounting portion and said support portion.
